(19) United States
(12) Patent Application Publication
(10) Pub. No.: US 2022/0414320 A1
(43) Pub. Date: Dec. 29, 2022

(54) INTERACTIVE CONTENT GENERATION

(71) Applicant: Microsoft Technology Licensing, LLC, Redmond, WA (US)

(72) Inventors: William B. DOLAN, Kirkland, WA (US); Michel GALLEY, Seattle, WA (US); Yizhe ZHANG, Seattle, WA (US); Christopher John BROCKETT, Bellevue, WA (US)

(73) Assignee: Microsoft Technology Licensing, LLC, Redmond, WA (US)

(21) Appl. No.: 17/356,440

(22) Filed: Jun. 23, 2021

(51) Int. Cl. G06F 40/169; G06F 3/0481; G06F 3/0484; G06F 40/40; G06F 40/30

(52) U.S. Cl. CPC G06F 40/169; G06F 3/0481; G06F 3/0484; G06F 40/40; G06F 40/30

(57) ABSTRACT

Aspects of the present disclosure relate to techniques for interactive content generation. In examples, processed content may be produced by a generative model based on a content seed, such as a sentence or paragraph. User input associated with the processed content may be received, for example to revise the processed content or provide additional input with respect to a subpart of the processed content that is associated with a low confidence score. A generative model may produce updated processed content based at least in part on the previously processed content, the user input, and/or, in some examples, additional content, as may be indicated by a user. Thus, a user may iterate on processed content that is produced by such generative models through successive interactions, thereby enabling the user to provide input to the generative model as part of the content generation process.

### BACKGROUND

A user may utilize processed content when drafting a document, as may be produced by a generative model. However, the content generation process may offer little or no opportunity for user interaction, such that the user is unable to adapt the processed content for a specific purpose or to remedy stylistic or factual errors. Thus, such a one-shot approach may require the user to manually revise the content or forego content generation in favor of manual document drafting, both of which result in added time and effort required on the part of the user.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to techniques for interactive content generation. In examples, processed content may be produced by a generative model based on a content seed, such as a sentence or paragraph. User input associated with the processed content may be received, for example to revise the processed content or provide additional input with respect to a subpart of the processed content that is associated with a low confidence score. A generative model may produce updated processed content based at least in part on the previously processed content, the user input, and/or, in some examples, additional content, as may be indicated by a user. Thus, a user may iterate on content that is produced by such generative models through successive interactions between the user and, for example, a document service implementing the aspects described herein, thereby enabling the user to provide input to the generative model as part of the content generation process.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for interactive content generation according to aspects described herein.

FIG. 2A illustrates an overview of an example method for generating content based on a content seed according to aspects described herein.

FIG. 2B illustrates an overview of an example method for generating updated content in response to an iterative generation request according to aspects described herein.

FIG. 3A illustrates an overview of an example method for processing user input to obtain processed content and display uncertain subparts according to aspects described herein.

FIG. 3B illustrates an overview of an example method for processing user input to update processed content according to aspects described herein.

FIGS. 4A-4D illustrate overviews of example views for interactive content generation according to aspects described herein.

FIG. 5 is a block diagram illustrating example physical components of a computing device with which aspects of the disclosure may be practiced.

FIGS. 6A and 6B are simplified block diagrams of a mobile computing device with which aspects of the present disclosure may be practiced.

FIG. 7 is a simplified block diagram of a distributed computing system in which aspects of the present disclosure may be practiced.

FIG. 8 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a user may incorporate content produced by a generative model into a document as part of the drafting process. For example, the user may use the content as a first draft or may add the content to a pre-existing draft. A generative model may be used to produce the content, for example based on a phrase or sentence, among other content seeds. However, aside from altering the content seed, the user may be unable to affect the resulting content that is produced by the generative model. Thus, if the content is stylistically deficient or factually incorrect, the user may have limited choices for addressing such issues, for example by either manually revising the generated content or eschewing the generative content altogether.

Accordingly, aspects of the present disclosure relate to interactive content generation techniques, where a user may interactively adapt processed content through iterative application of a generative model to update the content according to various user inputs. In examples, the generative model may be trained according to a corpus of content, for example content from the Internet, from a computing device of the user, and/or from a shared content source, among other examples. In some instances, the user may further provide an additional content source for use by the generative model or additional content associated with the user (e.g., personal documents, documents of the user's team, etc.) may be used, thereby grounding the processed content according, at least in part, to the additional content.

A content seed may be used by the generative model to produce processed content. For example, the content seed may be one or more words, sentences, or paragraphs. It will be appreciated that content need not be restricted to prose or even textual content, such that the iterative content generation aspects described herein are applicable to text (e.g., written language, code, etc.), images, video, and/or audio, among other examples. In some instances, the content seed may be an initial draft prepared by a user or, as another example, the user may provide a summary or set of instructions that are used by the generative model to produce processed content in the form of a first draft. For example, a content seed may comprise an indication of a writing style and/or additional content for use in grounding the generative model. Further, similar aspects may be applied in collaborative editing scenarios, where multiple users provide user input that is used to produce processed content accordingly.

As used herein, processed content includes, but is not limited to, content produced by a generative model, user-provided content that has subsequently been processed (e.g., as may be used by a generative model to produce additional generated content), and/or content for which an indication has been received marking the content as final by a user, among other examples. Thus, it will be appreciated that processed content need to be exclusively machine-generated. Further, processed content need not refer to the entire content of a document. Additionally, aspects of the present disclosure may be used as part of editing an existing document or as a starting point of a new document, among other examples.

As an example, generative models include generative language transformer models, vision-and-language models, or code-based models. Generative transformer models include autoregressive language models leveraging deep learning to produce human-like text via prediction. Transformer-based architectures, such as masking transformer-attention models with a directional bias (e.g., directional forward or reverse), may provide improved results in natural language processing scenarios. Such transformer models may be trained on large quantities of data, such as millions of documents using semi-supervised learning methods including word masking and prediction. Sentence generation tasks, for example, can utilize sampling from these language models which give probability distributions of the subsequent sentence or words in light of previous contexts according to the directional bias.

The generative model may generate a set of confidence scores, where each confidence score is associated with a subpart of the processed content. As used herein, a subpart of content may include a word, a sentence, a paragraph, or other text span, as well as a region of an image, among other examples. It will be appreciated that a subpart need not start and end at such boundaries and may, for example, comprise subparts of multiple sentences. In examples, the set of confidence scores may be ranked to identify one or more subparts having comparatively low associated confidence scores (referred to herein as “uncertain subparts”). As a result, user input may be requested in association with a subpart having a low confidence score, such that the generative model may be used to update the processed content according to the user input. For example, such uncertain subparts may be graphically emphasized to the user (e.g., using a different background color, font color, text size, and/or text style) or user interface elements may be associated with the uncertain subparts so as to draw user attention to the subparts accordingly, among other examples.

Subparts having comparatively low confidence scores may be prioritized to reduce the amount of user input requested from the user, thereby reducing the likelihood of user annoyance and the amount of effort required on the part of the user. It will be appreciated that, in other examples, subparts may be prioritized differently, for example based on an estimated amount of effort required on the part of the user, computational resource utilization associated with producing updated processed content, or in accordance with a user preference.

In other examples, user input may be received in the form of one or more revisions to the processed content. As an example, a user may revise a sentence or add a paragraph, such that the generative model may be used to update one or more subparts of the processed content accordingly. For instance, a user may change a city or add additional detail with respect to a range of dates described by the document, such that the generative model may produce updated processed content having additional or different detail based on such additions or changes. In such instances, the generative model may use preceding content and subsequent content as context with which to produce the updated processed content. As a further example, user input may be received using revision functionality provided by a document editor, such as a comment on a subpart of the processed content. The comment may be processed according to natural language understanding techniques to enable the user to converse with an automated conversational agent regarding potential changes to the processed content.

Thus, user input may be received in response to prompts (e.g., associated with subparts having a low confidence score), directly to the processed content (e.g., as additions, changes, or deletions), or as part of a communication session between the user and an automated conversational agent, among other examples. As another example, user input associated with processed content may be identified in conversation associated with or external to the document, such as in electronic communications among a group of users. Further, such modes of user input need not be mutually exclusive, such that a user may provide user input using a combination of such modes, for example relating to similar or different changes to the processed content. In examples, an indication of additional content for use in grounding the generative model may be used in combination with the user input described above, such that the updated processed content may be generated in view of such additional content. Further, as updated processed content is produced, the set of confidence scores may change, such that uncertain subparts that are emphasized may be updated accordingly. For example, as a result of prioritizing subparts having the lowest confidence scores, remaining subparts for user disambiguation may be reduced more quickly than in instances where a user first addresses subparts having higher confidence scores.

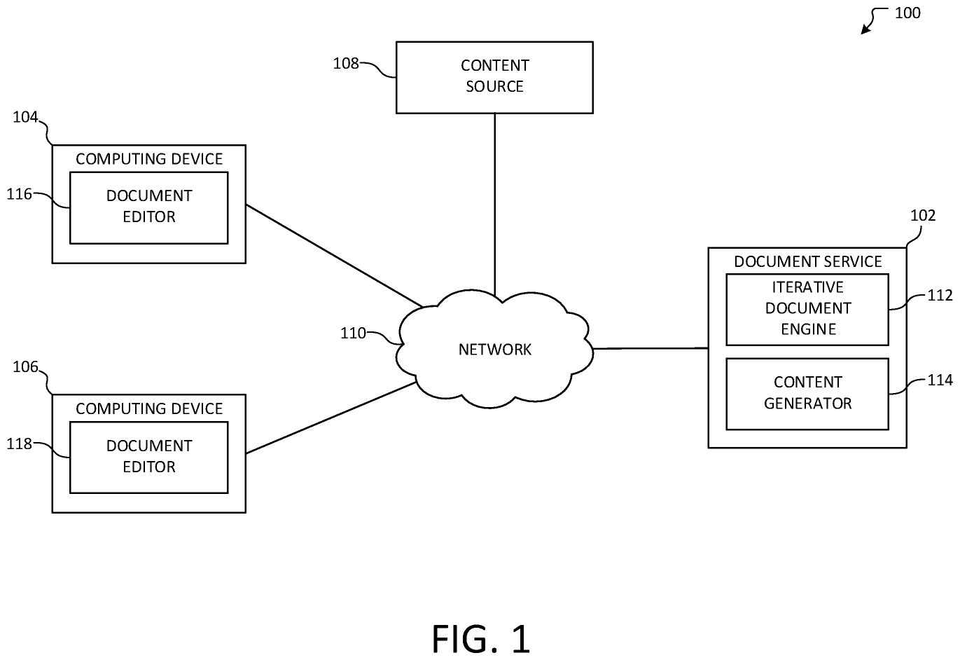

FIG. 1 illustrates an overview of an example system 100 for interactive content generation according to aspects described herein. As illustrated, system 100 comprises document service 102, computing device 104, computing device 106, content source 108, and network 110. In examples, document service 102, computing device 104, computing device 106, and/or content source 108 communicate via network 110, which may comprise a local area network, a wireless network, or the Internet, or any combination thereof, among other examples.

Document service 102 is illustrated as comprising iterative document engine 112 and content generator 114. In examples, iterative document engine 112 receives a request from computing device 104 and/or computing device 106 to produce processed content, for example according to a content seed. In other examples, iterative document engine 112 receives a request to generate updated processed content based on user input according to aspects described herein.

As a result, iterative document engine 112 may utilize content generator 114 to produce processed content and updated generative content accordingly. For example, iterative document engine 112 may receive an indication of document history associated with previously processed content for which updated processed content is requested. As another example, document service 102 may maintain at least a part of the document history, as may be the case in instances where at least a part of the document editing functionality is provided by document service 102. For example, document service 102 may provide a collaborative and/or cloud-based document editing service, with which document editors 116 and 118 may be used.

The document history may comprise past versions of the processed content, previously received user inputs, one or more subparts that a user has indicated as final, among any of a variety of other historical information associated with processed content. Accordingly, iterative document engine 112 may use the historical information as context for content generator 114, for example to ensure content generator 114 does not continually revise aspects of the processed content that have been previously adapted or marked as final by a user. Absent such aspects, processed content may fail to eventually substantially converge after successive iterations of the interactive content generation techniques described herein.

As discussed above, content generator 114 may be a generative model trained using to any of a variety of content, such as content from the Internet, from a corporate intranet, and/or from content associated with one or more users of computing device 104 and/or computing device 106. As noted above, content generator 114 may generate a set of confidence scores associated with subparts of the processed content. As a result, iterative document engine 112 may process the set of confidence scores to identify subparts for which to request user input or, as another example, the set of confidence scores may be provided to a document editor, such as document editor 116 or document editor 118 of computing devices 104 and 106, respectively, such that it may be processed locally.

It will be appreciated that content generator 114 need not be restricted to a single generative model. Rather, content generator 114 may comprise multiple generative models, for example according to different types of content, different styles, different languages, different locales, and/or different subject matter. As another example, iterative document engine 112 may select a specific generative model according to a user's progression in the drafting process. For example, a first model may be used to initially provide processed content (e.g., a rough draft), while a second model may be used to provide updated processed content (e.g., to refine the content at a later point in the drafting process).

System 100 is further illustrated as comprising computing devices 104 and computing device 106, which further comprise document editor 116 and document editor 118, respectively. Computing devices 104 and 106 are similar and aspects of each are therefore not necessarily re-described separately below in detail. With reference to computing device 104, computing device 104 may be any of a variety of computing devices, including, but not limited to, a mobile computing device, a tablet computing device, a laptop computing device, or a desktop computing device. Document editor 116 may be any of a variety of applications usable to edit any of a variety of types of content according to aspects described herein. In examples, document editor 116 may execute natively on computing device 104 or, as another example, document editor 116 may be a web application (e.g., provided by document service 102) executing in a browser of computing device 104, or any combination thereof. Example document editors include, but are not limited to, word processing editors, code editors, image editors, audio editors, and video editors.

In examples, aspects of the present disclosure may be used in the context of collaborative document editing, where a user of computing device 104 and a user of computing device 106 may each collaborate on the same document. In such instances, the users may be referred to as collaborators. For example, iterative document engine 112 may receive user input from both computing devices 104 and 106 and provide processed content for presentation to each user via document editors 116 and 118, respectively. In such instances, each user may participate in iterative content generation, for example communicating with each other (e.g., as comments within the document or exchanging out-of-band communications separate from the document). At least a part of such communications may be processed according to natural language understanding techniques, such that user input associated with processed content may be identified and used to cause content generator 114 to produce updated processed content accordingly.

System 100 is further illustrated as comprising content source 108, which may comprise any of a variety of content. For example, content source 108 may comprise personal content of a user of computing device 104 and/or computing device 106, content of a corporate intranet, or content that was not previously used to train a generative model of content generator 114. In examples, an indication may be provided to content generator 114 to use additional content from content source 108 to ground the generative model when producing processed content according to aspects described herein. For instance, the indication may be provided as a result of user input received from document editor 116 and/or 118, where a user may have selected content source 108 for additional content. Such a selection may be received in response to a prompt provided to the user or as an instruction that is part of a content seed, among other examples. As a further example, iterative document engine 112 may automatically identify additional content from content source 108 based on an association between a user of computing device 104 and/or 106, among other examples, such that the additional content is used to ground the processed content accordingly.

Thus, it will be appreciated that aspects described herein need not be limited to strictly local or cloud-based document editing, and the aspects described above with respect to document service 102, computing device 104, computing device 106, and content source 108 may be distributed among such devices according to any of a variety of paradigms. For example, iterative content generation may occur local to computing device 104 or, as another example, content source 108 may be part of computing device 104, such that document editor 116 transmits at least a part of the content therein to document service 102.

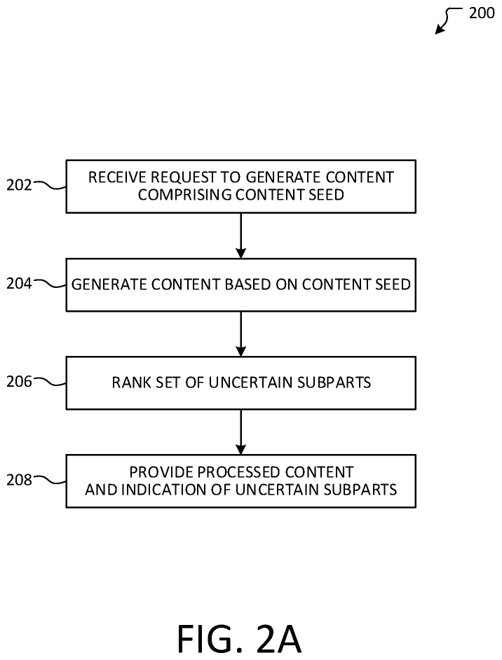

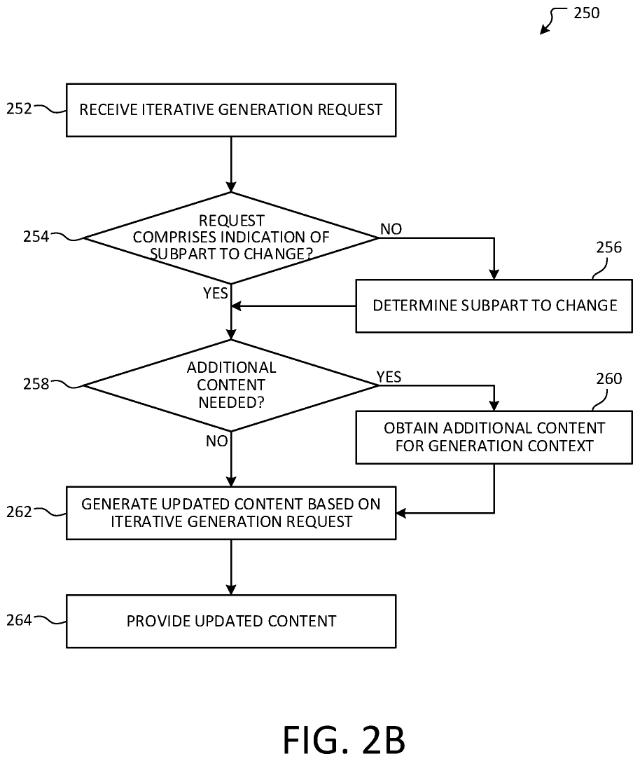

FIG. 2A illustrates an overview of an example method 200 for generating content based on a content seed according to aspects described herein. In examples, aspects of method 200 are performed by a document service, such as document service 102 discussed above with respect to FIG. 1. In other aspects, similar techniques may be used to provide processed content local to a computing device, such as computing device 104 or 106 discussed above with respect to FIG. 1.

Method 200 begins at operation 202, where a request is received to generate content. Such a request may be referred to herein as a content generation request. The request may comprise a content seed, such as one or more words, sentences, or paragraphs. As noted above, the content seed may comprise instructions for producing processed content or at least a part of a first draft prepared by a user. The request may be received from a document editor, such as document editor 116 or 118 discussed above with respect to computing devices 104 and 106, respectively, in FIG. 1.

At operation 204, content is generated based on the received content seed. For example, a generative model may be used to produce the processed content. In examples, operation 204 comprises selecting a generative model from a set of available models, as was discussed above with respect to content generator 114 in FIG. 1. In some instances, the content seed received at operation 202 may comprise an indication of additional content with which to ground the generative model, such that operation 204 may comprise obtaining the additional content as necessary (e.g., from a content source such as content source 108 in FIG. 1) and grounding the generative model accordingly.

Flow progresses to operation 206, where uncertain subparts of the processed content are ranked. In examples, operation 204 further comprises generating a set of confidence scores associated with the processed content. For example, the processed content may be segmented into multiple subparts, where each subpart has an associated confidence score. The resulting set of confidence scores may be ranked, for example to prioritize subparts having comparatively low associated confidence scores, based on an estimated amount of effort required on the part of the user to address a low confidence score, computational resource utilization associated with producing updated processed content based on a change to a content subpart, or in accordance with a user preference, among other examples. In examples, operation 206 may be omitted, such that uncertain subparts are ranked by a computing device rather than a document service, among other examples.

At operation 208, the processed content of operation 204 is provided in conjunction with an indication of the ranked uncertain subparts from operation 206. For example, the indication may comprise only a subset of the ranked subparts, such that a predetermined number of uncertain subparts may be provided in response to the content generation request. In other examples, the entire list of ranked uncertain subparts may be provided. In some instances, operation 208 comprises generating document history associated with the processed content, such that the document history may be accessible for subsequent applications of a generative model according to aspects described herein. In other instances, such history may be maintained by a computing device other than the document service. Method 200 terminates at operation 208.

FIG. 2B illustrates an overview of an example method 250 for generating updated content in response to an iterative generation request according to aspects described herein. In examples, aspects of method 250 are performed by a document service, such as document service 102 discussed above with respect to FIG. 1. In other aspects, similar techniques may be used to provide processed content local to a computing device, such as computing device 104 or 106 discussed above with respect to FIG. 1.

Method 250 begins at operation 252, where an iterative generation request is received. For example, the iterative generation request may be received from a document editor, such as document editor 116 or 118 discussed above with respect to computing devices 104 and 106, respectively, in FIG. 1. The request may comprise an indication of previously processed content (e.g., as may have been generated according to method 200 discussed above with respect to FIG. 2A). In some instances, the request further comprises at least a part of a document history associated with the previously processed content, a user input received from a user, and/or an indication of additional content. As a further example, the request may comprise an identifier associated with the previously processed content, such that a document history may be identified using the identifier, as may be the case when the document history is maintained by a document service.

At determination 254, it is determined whether the request comprises an indication of a subpart to change. For example, in instances where user input is received to revise a subpart of the processed content or a comment is made on a subpart using revision functionality, the user input may be specifically associated with one or more subparts. By contrast, if user input is received as part of natural language input or in response to a prompt, the user input may not have an explicit association with a subpart of the document.

Accordingly, if it is determined that the request does not comprise an indication of the subpart to change, flow branches “NO” to operation 256, where one or more subparts to change may be determined. For example, a subpart may be identified by evaluating subparts of the processed content to identify one or more subparts having content similar to that with which the user input is associated. This may comprise evaluating semantic similarity of the received user input and the content subparts. It will be appreciated that any of a variety of additional or alternative techniques may be used to determine one or more subparts to change, for example based at least in part on associated confidence scores or prompting a user for clarification with respect to a subpart to change. Flow progresses to determination 258, which is described below.

By contrast, if it is determined that the request comprises an indication of a subpart to change, flow instead branches “YES” to determination 258, where it is determined whether additional content is needed. For example, determination 258 may comprise evaluating user input with respect to a subpart to change to determine whether output of a generative model exhibits a confidence score above a predetermined threshold when generating updated content for the subpart associated with the user input. As another example, determination 258 may comprise evaluating the user input to determine whether the type of user input is associated with an instance where additional content may be used to ground the generative model. In some instances, the user input may comprise non-linguistic grounding. For example, the user input may indicate additional content for use by the generative model (e.g., “update this section to reflect sales trends in this spreadsheet” or “give a description of that anomalous region in his ankle MRI”), such that determination 258 comprises identifying such non-linguistic grounding and determining to obtain the identified additional content. Thus, any of a variety of techniques may be used to determine whether additional content is need.

Accordingly, if it is determined that additional content is needed, flow branches “YES” to operation 260, where additional content is obtained for generation context. For example, operation 260 may comprise providing an indication to the client device to request a selection of additional content from the user. In another example, the additional content may be automatically determined, for example based on an association with the user or from the user input (e.g., as may be the case when the user input comprises an indication of non-linguistic grounding). Operation 260 may comprise accessing the additional content from a content source, such as content source 108 discussed above with respect to FIG. 1. Flow progresses to operation 262, which is discussed below.

If, however, it is determined that additional content is not needed, flow instead branches “NO” from determination 258 to operation 262, where updated content is generated based on the received iterative generation request. For example, the updated processed content may be produced based on a document history, a preceding part of the previously processed content, and/or a subsequent part of the previously processed content. In instances where additional content was obtained at operation 260, the additional content maybe used to ground the generative model to the context provided by the additional context. For example, non-linguistic grounding (e.g., as discussed above with respect to determination 258 and operation 260) may be used to produce processed content based at least in part on additional content identified therein. As an example, the processed content may be produced from numerical data, audio data, temperature data, image data, and/or sensor data of the additional content, among other examples. In examples, operation 262 comprises using a generative model selected from a set of available models, as was discussed above with respect to content generator 114 in FIG. 1. In some instances, the generative model applied at operation 262 may differ from that which was used to generate the previously processed content (e.g., as a result of performing operation 204 discussed above with respect to method 200 in FIG. 2A or performing a previous iteration of operation 262).

At operation 264, the updated content is provided in response to the received iterative generation request. In examples, operation 264 comprises updating a document history associated with the processed content, such that the document history may be accessible for subsequent iterations of method 250. In other instances, such history may be maintained by a computing device other than the document service. Operations 262 and 264 may further comprise generating an updated set of confidence scores and, in some instances, ranking the set of confidence scores accordingly, such that low-confidence subparts may be highlighted to a user as described above, among other examples. Method 250 terminates at operation 264.

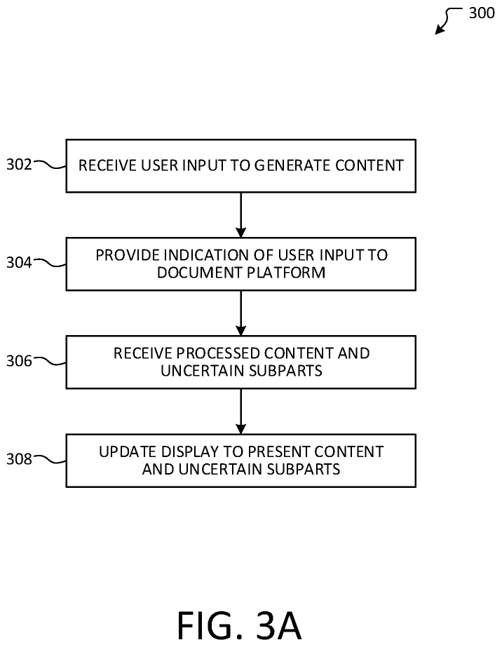

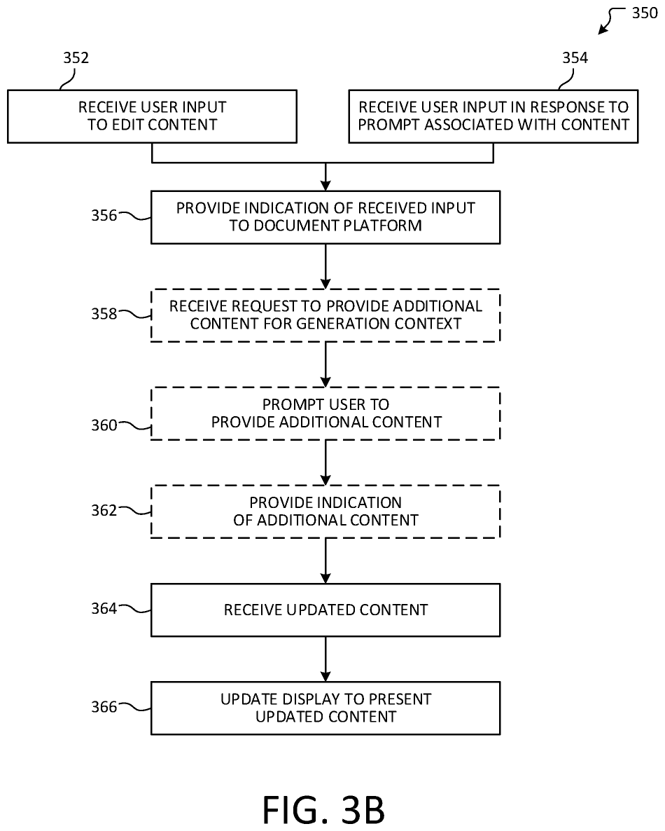

FIG. 3A illustrates an overview of an example method 300 for processing user input to obtain processed content and display uncertain subparts according to aspects described herein. In examples, aspects of method 300 are performed by a document editor, such as document editor 116 or 118 discussed above with respect to computing devices 104 and 106, respectively, in FIG. 1. In other examples, similar aspects may be performed by a document service, such as document service 102.

Method 300 begins at operation 302, where user input is received to generate content. For example, user input may be received at a document editor, such as document editor 116 or 118. In examples, the user input may comprise actuation of a user interface element to generate a rough draft based on a content seed. In response, the user may be prompted to provide the content seed, for example comprising instructions for content that should be generated by a generative model. As another example, the user input may comprise actuation of a user interface element to use an existing draft as the content seed.

Flow progresses to operation 304, where an indication of the user input is provided to a document service, such as document service 102 discussed above with respect to FIG. 1. In examples, the document platform may be performing aspects of method 200 discussed above with respect to FIG. 2A. For example, the indication may comprise a content seed associated with the user input that was received at operation 302.

At operation 306, processed content and a set of uncertain subparts are received in response to the indication that was provided at operation 304. For example, the content and uncertain subparts may be received as a result of the document service performing aspects of operation 208 discussed above with respect to method 200 of FIG. 2A. In examples, the received set of uncertain subparts is ranked as described above. As another example, operation 306 may further comprise receiving an identifier associated with the processed content, such that the identifier may subsequently be provided by a client device, for example as part of an iterative generation request described below with respect to method 350 in FIG. 3B.

Flow progresses to operation 308, where a display is updated to present the processed content and the set of uncertain subparts. For example, the document editor may be updated to comprise a document containing the received processed content or an existing draft may be updated to comprise the processed content (e.g., in addition to or as an alternative to existing content). Content within the document associated with uncertain subparts may be emphasized or otherwise noted so as to call the user's attention to the uncertain subparts. In examples, operation 308 may comprise prompting the user for user input associated with an uncertain subpart or, as another example, the user may choose to interact with uncertain subparts presented by the document editor. Thus, it will be appreciated that any of a variety of techniques may be used to present processed content and emphasize uncertain content subparts therein. Method 300 terminates at operation 308.

FIG. 3B illustrates an overview of an example method 350 for processing user input to update processed content according to aspects described herein. In examples, aspects of method 350 are performed by a document editor, such as document editor 116 or 118 discussed above with respect to computing devices 104 and 106, respectively, in FIG. 1. In other examples, similar aspects may be performed by a document service, such as document service 102.

As illustrated, method 350 may begin at operation 352 or operation 354, each of which are described in further detail below. It will be appreciated that operations 352 and 354 are provided as examples of user input and, in other examples, any of a variety of additional or alternative user inputs may be received in association with processed content.

Method 350 may start at operation 352, where user input is received to edit previously processed content. For example, the user input may comprise a user adding content, revising content, or removing content using the document editor. As another example, the user may alter formatting indicating that the content is of a higher or lower importance, among other examples. Flow then progresses to operation 356, which is described below.

In other examples, method 350 may start at operation 354, where user input is received in response to a prompt associated with the processed content. For example, the user input may be received in association with an uncertain subpart that was highlighted by the document editor as a result of having a low confidence score. Examples of such user input include, but are not limited to, clarification, additional instructions, and/or a selection of a replacement subpart.

At operation 356, an indication of the received input is provided to the document service. The indication may be provided as an iterative generation request, similar to the iterative generation request discussed above with respect to operation 252 of method 250 in FIG. 2B. For example, the request may comprise an indication of previously processed content (e.g., as may have been obtained according to method 300 discussed above with respect to FIG. 3A). In some instances, the request further comprises at least a part of a document history associated with the previously processed content, user input received from a user at operation 352 or 354, and/or an indication of additional content (e.g., as may have been received as part of the user input at operations 352 or 354). As a further example, the request may comprise an identifier associated with the previously processed content, such that a document history may be identified using the identifier (e.g., as may have been received as part of operation 306 discussed above with respect to method 300 in FIG. 3A).

Operations 358-362 are illustrated using dashed boxes to indicate that, in some examples, flow progresses from operation 356 to operation 358, where a request is received to provide additional content for generation context. For example, the request may be received from a document service performing aspects of operation 260 discussed above with respect to method 250 in FIG. 2B. For example, the request may comprise a natural language statement to indicate the content that is being requested. As another example, the request may include an aspect of the received user input to indicate that additional clarification is being requested.

Accordingly, flow may progress to operation 360, where a user is prompted to provide additional content. For example, the user may manually create the additional content, upload an existing document, or provide a uniform resource locator (URL) to the additional content, among other examples.

At operation 362, an indication of the additional content is provided. In some instances, operation 360 may be omitted, such that method 300 may comprise automatically determining additional content to provide at operation 362. For example, the additional content may be automatically identified from a set of documents associated with the user (e.g., as may be stored by the user's device or in association with the user's account at a cloud platform) based on semantic similarity to the previously processed content or based on a user preference. Accordingly, it will be appreciated that any of a variety of techniques may be used to identify and provide additional content for use by a generative model. Flow progresses to operation 364, which is discussed below.

In other examples, flow my pass from operation 356 to operation 364, as may be the case when a document service determines additional content is not needed (e.g., a determination similar to determination 258 discussed above with respect to method 250 of FIG. 2B).

At operation 364, updated processed content is received. For example, the updated processed content may be received as a result of the document service performing aspects of operation 264. The updated processed content may comprise one or more additional or replacement subparts for the previously processed content, or may comprise an indication to remove one or more subparts of the previously processed content. In other examples, the updated processed content may be received as a replacement for the entirety of the previously processed content. In some instances, a set of uncertain subparts may be received as described above. Thus, it will be appreciated that any of a variety of techniques may be used obtain updated processed content.

Moving to operation 366, a display is updated to present the updated processed content. For example, content within the document editor may be updated to reflect the updated processed content that was received at operation 364, for example by adding, removing, or changing subparts of the content displayed by the document editor. In instances where a set of uncertain subparts is received at operation 364, content within the document associated with such uncertain subparts may be emphasized or otherwise noted as described herein. Thus, it will be appreciated that any of a variety of techniques may be used to present updated processed content. Method 350 terminates at operation 366.

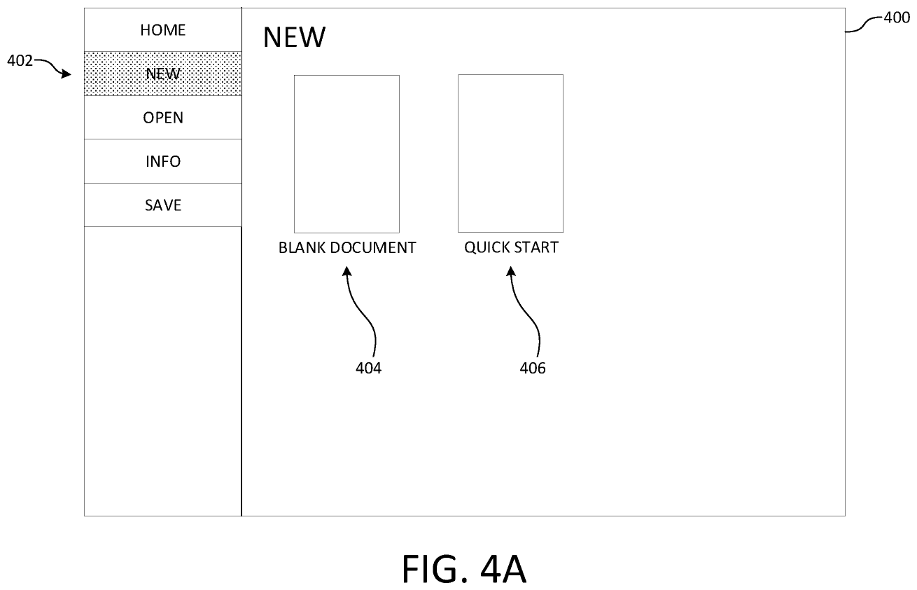

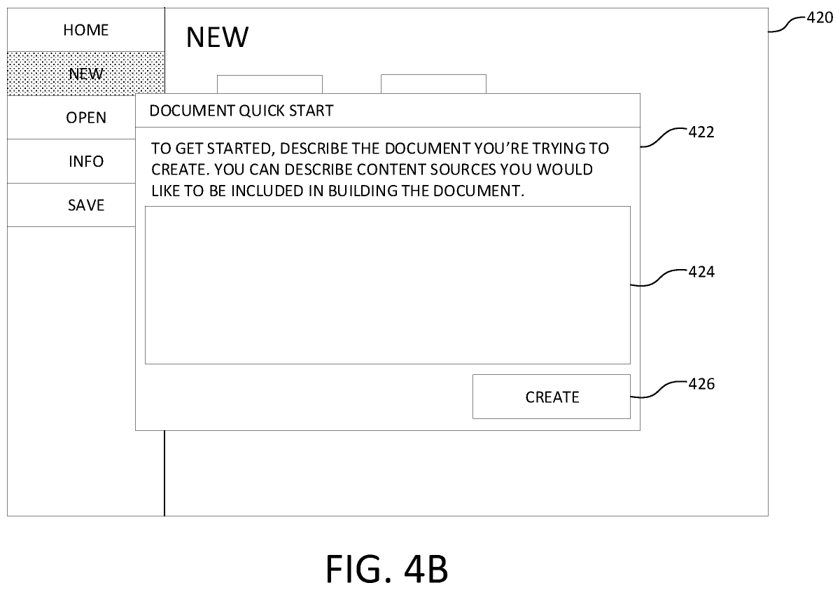

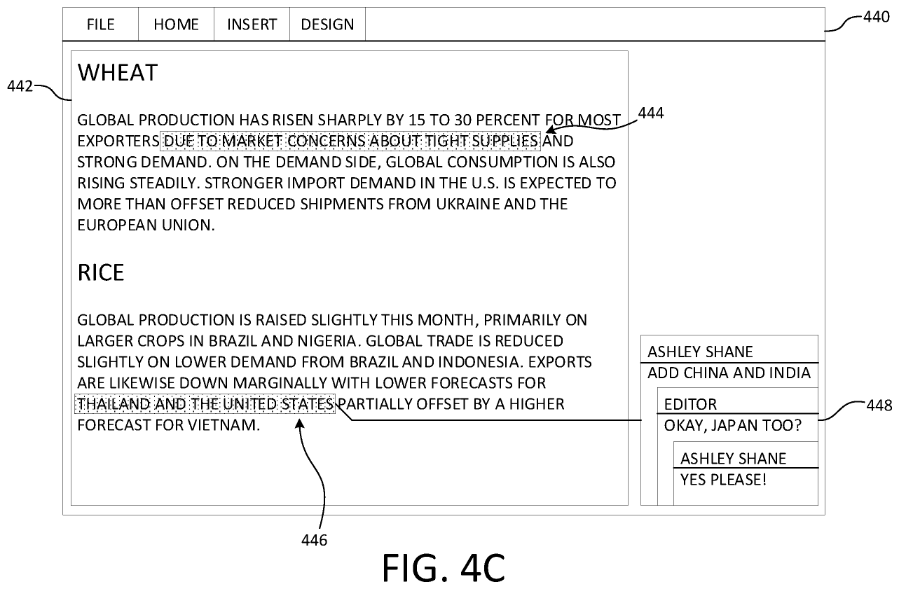

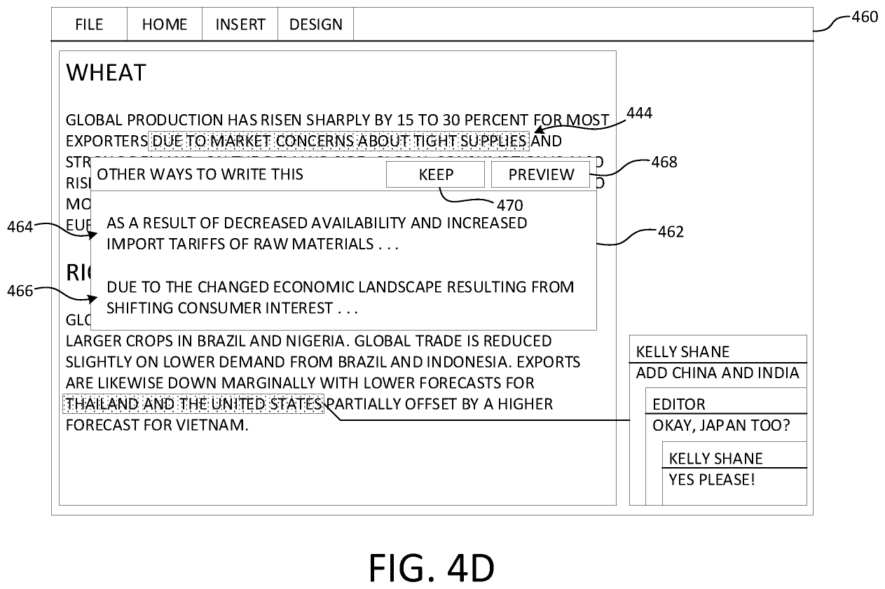

FIGS. 4A-4D illustrate overviews of example views 400, 420, 440, and 460 for interactive content generation according to aspects described herein. Views 400, 420, 440, and 460 illustrate example user experience aspects that may be implemented by a document editor, such as document editor 116 or 118 discussed above with respect to computing devices 104 and 106, respectively, in FIG. 1. While instant examples are described in the context of textual content, it will be appreciated that similar techniques may be applied to any of a variety of additional or alternative content types.

With reference to FIG. 4A, view 400 illustrates an example new document creation pane 402, comprising blank document element 404 and quick start element 406. In examples, a user may actuate blank document element 404 to cause the document editor to create a new document in which a user may manually draft content. In such examples, the user may subsequently utilize the interactive document generation aspects described herein by actuating an iterative document editing assistant user interface element (not pictured), where the drafted content may form part of a content seed.

In other examples, the user may actuate quick start element 406, thereby causing the document editor to prompt the user for input to be used as a content seed with which to produce processed content to form a first draft. View 420 of FIG. 4B illustrates such an example quick start prompt 422, where instructions to describe the content and, optionally, one or more additional content sources are presented. Accordingly, user input may be received in text box 424, after which the user may actuate create button 426 to cause the creation of processed content based on the content seed entered in text box 424 (e.g., according to method 200 and 300 of FIGS. 2A and 3A, respectively).

View 440 of FIG. 4C illustrates an example of the resulting processed content 442 that may be presented by the document editor. As illustrated, uncertain subparts 444 and 446 are emphasized, such that a user may interact with the uncertain subparts to provide clarification or select from a set of replacement subparts, among other examples. For example, comments 448 associated with uncertain subpart 446 indicate a user's instructions to add additional detail to the processed content. As illustrated, comments 448 are an example of user interaction (“Kelly Shane”) with an automated conversational agent (“Editor”) using natural language. It will be appreciated that any of a variety of alternative or additional interaction techniques may be used to receive similar user input associated with the processed content according to aspects described herein.

Uncertain subpart 444 illustrates another example, in which user actuation of uncertain subpart 444 causes prompt 462 in FIG. 4D to be presented. As illustrated, prompt 462 comprises a set of replacement subparts for user selection, such that the user may select replacement subpart 464 or 466 to replace uncertain subpart 444. Actuation of preview button 468 may cause the document editor to present updated processed content based on a user's selection of one of replacement subparts 464 or 466.

For example, as described above, other parts of the processed content may change as a result of a selection of replacement subpart 464 or 466, such that preview button 468 enables the user to preview such changes to determine whether uncertain subpart 444, replacement subpart 464, or replacement subpart 466 yields an improvement to the processed content of the document editor. In other examples, a user may actuate keep button 470 to indicate that uncertain subpart 444 should be retained rather than replaced. In other examples, a user may manually enter content to replace uncertain subpart 444, such that the processed content may be updated accordingly.

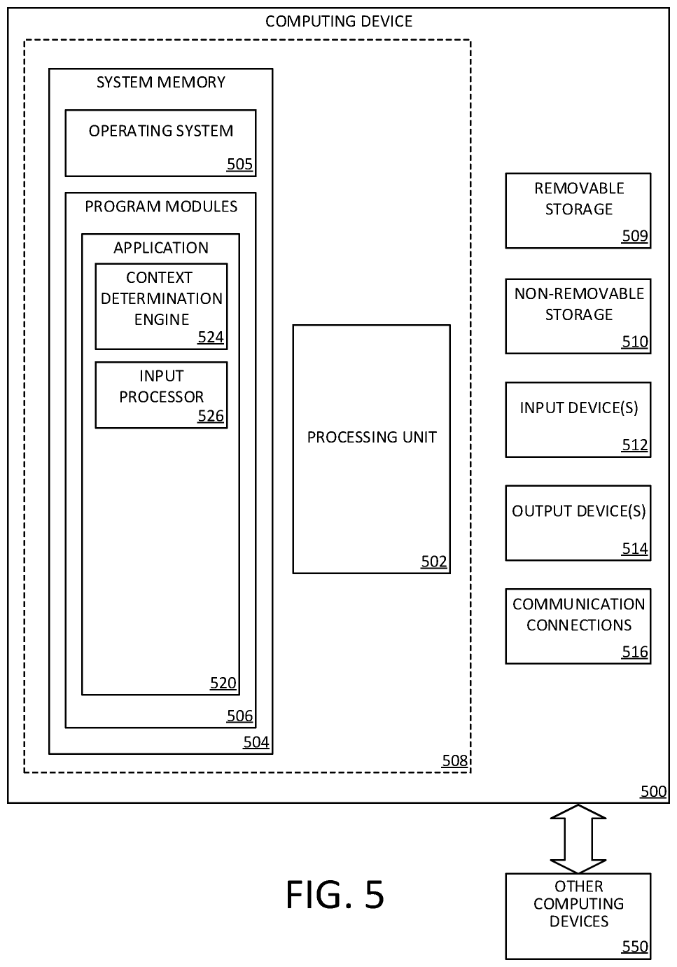

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including devices 104, 106, and/or 108, as well as one or more devices associated with document service 102 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may store context determination engine 524 and input processor 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

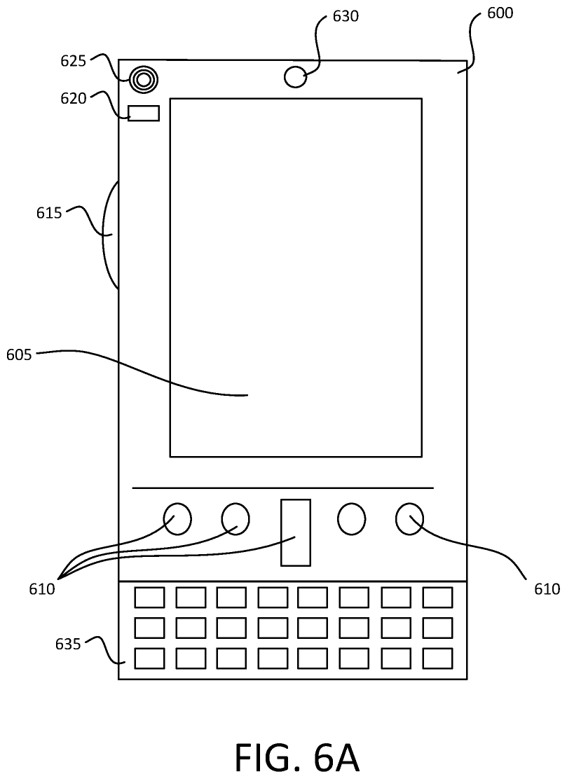

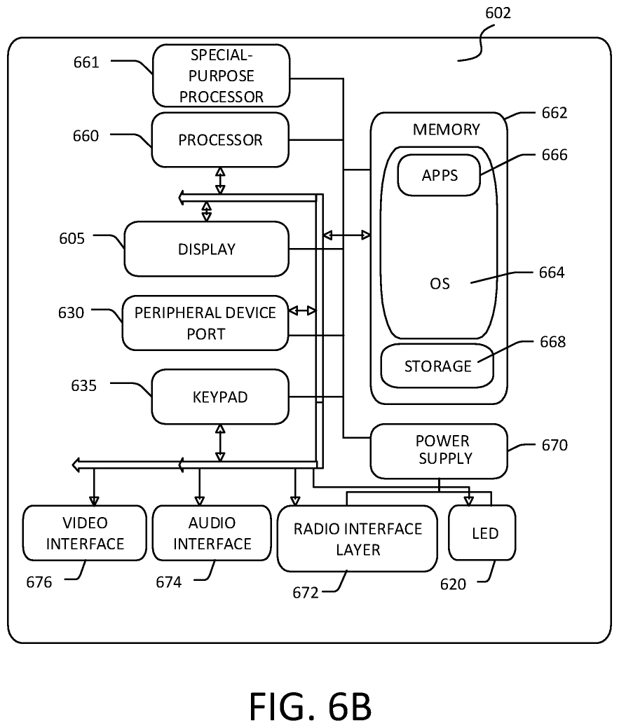

FIGS. 6A and 6B illustrate a mobile computing device 600, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 6A, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments.

In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display.

In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one embodiment, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600 described herein (e.g., search engine, extractor module, relevancy ranking module, answer scoring module, etc.).

The system 602 has a power supply 670, which may be implemented as one or more batteries. The power supply 670 might further include an external power source, such as an AC adapter or a powered docking cradle that supplements or recharges the batteries.

The system 602 may also include a radio interface layer 672 that performs the function of transmitting and receiving radio frequency communications. The radio interface layer 672 facilitates wireless connectivity between the system 602 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio interface layer 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio interface layer 672 or via a distributed computing network. Similarly, such data/information may be readily transferred between computing devices for storage and use according to well-known data/information transfer and storage means, including electronic mail and collaborative data/information sharing systems.

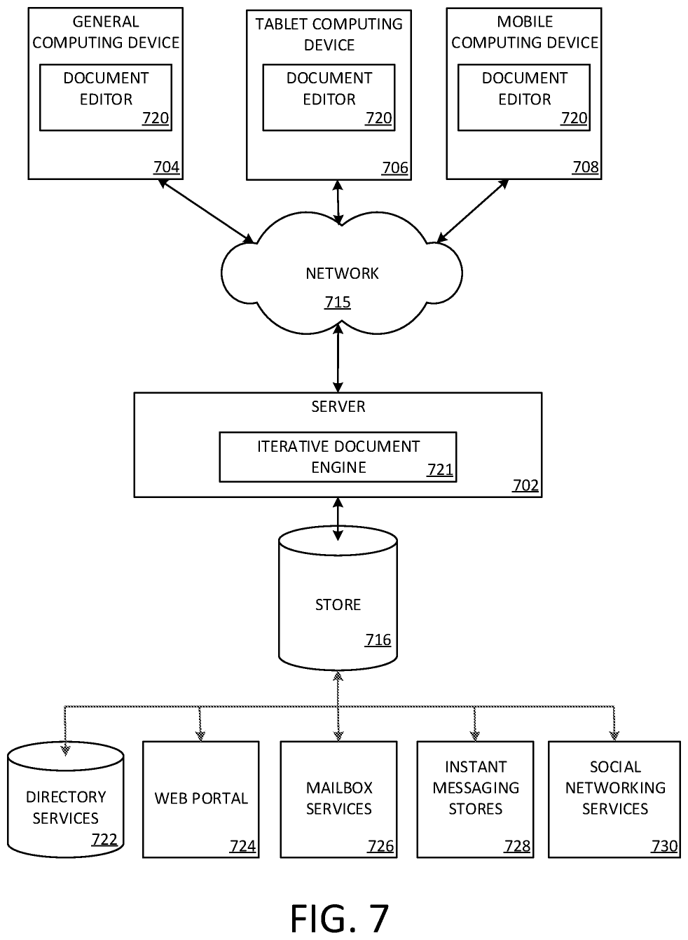

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 722, a web portal 724, a mailbox service 726, an instant messaging store 728, or a social networking site 730.

A document editor 720 may be employed by a client that communicates with server device 702, and/or iterative document engine 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these embodiments of the computing devices may obtain content from the store 716, in addition to receiving graphical data useable to be either pre-processed at a graphic-originating system, or post-processed at a receiving computing system.

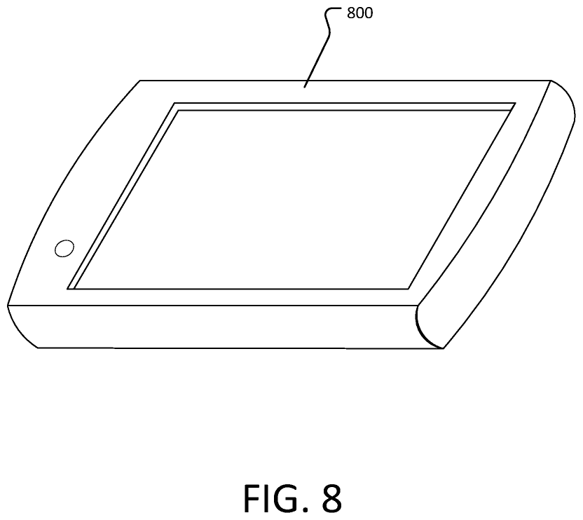

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, causes the system to perform a set of operations. The set of operations comprises: receiving a content generation request comprising a content seed; processing, using a generative model, the content seed to produce processed content; providing, in response to the content generation request, the processed content; receiving an iterative generation request comprising an indication of a user input associated with the processed content; processing, using the generative model, the user input based on the processed content to produce updated processed content; and providing, in response to the iterative generation request, the updated processed content. In an example, the generative model is selected from a set of generative language models according to the content seed. In another example, the generative model is a first generative model; the iterative generation request is a first iterative generation request; the user input is a first user input; the updated processed content is a first updated processed content; and the set of operations further comprises: receiving a second iterative generation request comprising an indication of a second user input; processing, using a second generative model different than the first language model, the second user input based on a document history associated with the processed content to produce a second updated processed content. In another example, the document history comprises: at least a part of the processed content; information associated with the first user input; and at least a part of the first updated processed content. In further example, processing the user input to produce updated processed content further comprises generating a set of confidence scores for subparts of the processed content; and providing the updated processed content further comprises providing a set of uncertain subparts based on the set of confidence scores. In yet another example, the set of uncertain subparts comprises the subparts ranked in ascending order according to associated confidence scores. In a further still example, processing the user input to produce updated processed content comprises identifying a subpart of the processed content associated with the user input based on a semantic similarity of the identified subpart and the user input.

In another aspect, the technology relates to a method for iterative content generation. The method comprises: providing, to a document service, a content generation request comprising a content seed; receiving, in response to the content generation request, processed content comprising a set of uncertain subparts; generating a display of a document editor comprising: at least a part of the processed content; and an uncertain subpart of the set of uncertain subparts; receiving user input associated with the uncertain subpart; providing, to the document service, an indication of the user input; receiving, from the document service, updated processed content; and updating the display based on the received updated processed content. In an example, the method further comprises: receiving user actuation of a quick start user interface element of the document editor; in response to the user actuation, displaying a quick start prompt; and receiving user input of the content seed at the quick start prompt. In another example, the content generation request is provided to the document service as a result of a user actuation of a create user interface element of the quick start prompt. In a further example, the method further comprises: receiving, from the document service, an indication of a collaborator comment on the uncertain subpart; and presenting the collaborator comment in association with the uncertain subpart. In yet another example, the method further comprises: receiving, from the document service, an indication of a natural language comment from an automated conversational agent associated with the uncertain subpart; and presenting the automated conversational agent comment in association with the uncertain subpart. In a further still example, the method further comprises: receiving, from the document service, a request to provide additional content; receiving user input indicating a content source for the additional content; and providing an indication of the content source to the document service in response to the request to provide the additional content.

In a further aspect, the technology relates to another method for iterative content generation. The method comprises: receiving a content generation request comprising a content seed; processing, using a generative model, the content seed to produce processed content; providing, in response to the content generation request, the processed content; receiving an iterative generation request comprising an indication of a user input associated with the processed content; processing, using the generative model, the user input based on the processed content to produce updated processed content; and providing, in response to the iterative generation request, the updated processed content. In an example, the generative model is selected from a set of generative language models according to the content seed. In another example, the generative model is a first generative model; the iterative generation request is a first iterative generation request; the user input is a first user input; the updated processed content is a first updated processed content; and the method further comprises: receiving a second iterative generation request comprising an indication of a second user input; processing, using a second generative model different than the first generative model, the second user input based on a document history associated with the processed content to produce a second updated processed content. In a further example, the document history comprises: at least a part of the processed content; information associated with the first user input; and at least a part of the first updated processed content. In a yet another example, processing the user input to produce updated processed content further comprises generating a set of confidence scores for subparts of the processed content; and providing the updated processed content further comprises providing a set of uncertain subparts based on the set of confidence scores. In a further still example, the user input comprises non-linguistic grounding associated with additional content; and processing the user input comprises producing updated processed content based at least in part on the additional content. In another example, processing the user input to produce updated processed content comprises identifying a subpart of the processed content associated with the user input based on a semantic similarity of the identified subpart and the user input.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
at least one processor; and
memory storing instructions that, when executed by the at least one processor, causes the system to perform a set of operations, the set of operations comprising:
receiving a content generation request comprising a content seed;
processing, using a generative model, the content seed to produce processed content;
providing, in response to the content generation request, the processed content;
receiving an iterative generation request comprising an indication of a user input associated with the processed content;
processing, using the generative model, the user input based on the processed content to produce updated processed content; and
providing, in response to the iterative generation request, the updated processed content.

2. The system of claim 1, wherein the generative model is selected from a set of generative language models according to the content seed.

3. The system of claim 1, wherein:
the generative model is a first generative model;
the iterative generation request is a first iterative generation request;
the user input is a first user input;
the updated processed content is a first updated processed content; and
the set of operations further comprises:
receiving a second iterative generation request comprising an indication of a second user input;
processing, using a second generative model different than the first language model, the second user input based on a document history associated with the processed content to produce a second updated processed content.

4. The system of claim 3, wherein the document history comprises:
at least a part of the processed content;
information associated with the first user input; and
at least a part of the first updated processed content.

5. The system of claim 1, wherein:
processing the user input to produce updated processed content further comprises generating a set of confidence scores for subparts of the processed content; and
providing the updated processed content further comprises providing a set of uncertain subparts based on the set of confidence scores.

6. The system of claim 5, wherein the set of uncertain subparts comprises the subparts ranked in ascending order according to associated confidence scores.

7. The system of claim 1, wherein processing the user input to produce updated processed content comprises identifying a subpart of the processed content associated with the user input based on a semantic similarity of the identified subpart and the user input.

8. A method for iterative content generation, the method comprising:
providing, to a document service, a content generation request comprising a content seed;
receiving, in response to the content generation request, processed content comprising a set of uncertain subparts;
generating a display of a document editor comprising:
at least a part of the processed content; and
an uncertain subpart of the set of uncertain subparts;
receiving user input associated with the uncertain subpart;
providing, to the document service, an indication of the user input;
receiving, from the document service, updated processed content; and
updating the display based on the received updated processed content.

9. The method of claim 8, further comprising:
receiving user actuation of a quick start user interface element of the document editor;
in response to the user actuation, displaying a quick start prompt; and
receiving user input of the content seed at the quick start prompt.

10. The method of claim 9, wherein the content generation request is provided to the document service as a result of a user actuation of a create user interface element of the quick start prompt.

11. The method of claim 8, further comprising:
receiving, from the document service, an indication of a collaborator comment on the uncertain subpart; and
presenting the collaborator comment in association with the uncertain subpart.

12. The method of claim 8, further comprising:
receiving, from the document service, an indication of a natural language comment from an automated conversational agent associated with the uncertain subpart; and
presenting the automated conversational agent comment in association with the uncertain subpart.

13. The method of claim 8, further comprising:
receiving, from the document service, a request to provide additional content;
receiving user input indicating a content source for the additional content; and
providing an indication of the content source to the document service in response to the request to provide the additional content.

14. A method for iterative content generation, the method comprising:
receiving a content generation request comprising a content seed;
processing, using a generative model, the content seed to produce processed content;
providing, in response to the content generation request, the processed content;
receiving an iterative generation request comprising an indication of a user input associated with the processed content;
processing, using the generative model, the user input based on the processed content to produce updated processed content; and
providing, in response to the iterative generation request, the updated processed content.

15. The method of claim 14, wherein the generative model is selected from a set of generative language models according to the content seed.

16. The method of claim 14, wherein:
the generative model is a first generative model;
the iterative generation request is a first iterative generation request;
the user input is a first user input;
the updated processed content is a first updated processed content; and
the method further comprises:
receiving a second iterative generation request comprising an indication of a second user input;
processing, using a second generative model different than the first generative model, the second user input based on a document history associated with the processed content to produce a second updated processed content.

17. The method of claim 16, wherein the document history comprises:
at least a part of the processed content;
information associated with the first user input; and
at least a part of the first updated processed content.

18. The method of claim 14, wherein:
processing the user input to produce updated processed content further comprises generating a set of confidence scores for subparts of the processed content; and
providing the updated processed content further comprises providing a set of uncertain subparts based on the set of confidence scores.

19. The method of claim 14, wherein:
the user input comprises non-linguistic grounding associated with additional content; and
processing the user input comprises producing updated processed content based at least in part on the additional content.

20. The method of claim 14, wherein processing the user input to produce updated processed content comprises identifying a subpart of the processed content associated with the user input based on a semantic similarity of the identified subpart and the user input.
